(19) United States
(12) Patent Application Publication
(10) Pub. No.: US 2012/0055453 A1
(43) Pub. Date: Mar. 8, 2012

(54) Fuel saving heater for internal combustion engine

(75) Inventor: Naiqiang Dong, Nanjiang (CN)

(73) Assignees: Rong Ying Lin; Lan Way

(21) Appl. No.: 13/068,605

(22) Filed: May 16, 2011

Related U.S. Application Data
(62) Division of application No. 11/590,033, filed on Oct. 31, 2006, now abandoned.
Application No. 11/590,033 is a division of application No. 11/899,096, filed on Sep. 4, 2007.

(30) Foreign Application Priority Data
Aug. 23, 2000 (CN) CN 2392923Y

(51) Int. Cl. F02M 53/02

(52) U.S. Cl. 123/557

(57) ABSTRACT

method for a fuel heating device regarding an engine in an automobile is performing processes of a catalyzing process, a stabilizing process, and a magnetizing process to improve the properties of a fuel prior to entrance into the combustion chambers of the engine. The device comprises a housing means further defining an inner chamber, inlet end, and outlet end. Multi-elements plates within the inner chamber and a multi-metallic layer on an infrared annular member in the center portion of the inner chamber are to promote the attributes of the fuel for efficient combustion. A fuel stabilizer at the inlet end is to regulate the amount and the pressure of the fuel for avoidance of fuel supply waste. A fuel magnetizer at the outlet end is to magnetize the attributes of the fuel for enhancing fuel vaporization concerning efficiency improvement.

### CROSS-REFERENCE TO RELATED APPLICATIONS

This divisional application claims the benefit of two prior patent applications of the Ser. No. 11/590,033 filed at Oct. 31, 2006 and the Ser. No. 11/899,096 filed at Sep. 4, 2007 by the same and sole inventor.

### BACKGROUND OF THE INVENTION

1. Field of the Invention

The invention generally relates to a method regarding an internal combustion engine in an automobile, and specifically to a fuel heating device to improve the properties of a fuel prior to entrance into the combustion chambers of the engine by catalyzing, stabilizing, and magnetizing the fuel flowing from a fuel tank in the automobile throughout the device, to promote the attributes of the fuel for efficient combustion in the chambers of the engine, to regulate the amount and the pressure of the fuel for avoidance of fuel supply waste in the chambers of the engine, to magnetize the attributes of the fuel for enhancing fuel vaporization concerning efficiency improvement in the chambers of the engine, and the fuel treated then to be delivered to the chambers of the engine of the automobile for fuel efficiency and pollution reduction.

2. Description of Prior Art

It is a well-known fact in automobile industry that hydrocarbon fuels like gasoline and diesel can be more efficiently burned for an internal combustion engine in an automobile if the properties of these fuels are improved prior to intended combustion. To significantly promote the combustion efficiency of the fuels, many engineers in prior art have designed numerous devices trying to improve the properties of the fuels above the level at gas stations delivered by refineries.

Although many devices of the prior art have proved to be operatively efficient in fuel saving for any type of engines of all automobiles, these devices definitely have attendant disadvantages in accompanying with the mere advantage of the combustion efficiency of the fuels. The disadvantages such as expensive price, bulky size, difficult installation, complex design, hard replacement, and unsafe use, apparently do not thus far justify for widespread adoptions or usages by either automobile manufacturers or car drivers.

### OBJECTS OF THE INVENTION

It is a main object of the present invention to provide an improved fuel heating device regarding an internal combustion engine in an automobile which is efficient in operation, inexpensive in price, compact in size, safe in use, easy in installation, simple in replacement, etc.

It is a further object of the present invention to provide a fuel heating device for the engine which can be readily retrofitted on any type and model of all automobiles.

It is a further object of the present invention to provide a fuel heating device for the engine which is elevating and maintaining the temperature of a fuel to be delivered to a carburetor or a fuel injector in the automobile within a preset temperature range below the boiling point of the fuel but substantially above the ambient temperature at various weather conditions.

It is a further object of the present invention to provide a fuel heating device which includes multi-elements plates and a multi-metallic layer to promote the attributes of the fuel for efficient combustion in the combustion chambers of the engine.

It is a further object of the present invention to provide a fuel heating device which includes a built-in fuel stabilizer to regulate the amount and the pressure of the fuel for avoidance of fuel supply waste in the chambers.

It is a further object of the present invention to provide a fuel heating device which includes a built-in fuel magnetizer to magnetize the attributes of the fuel for enhancing fuel vaporization concerning efficiency improvement in the chambers.

It is a further object of the present invention to provide a fuel heating device which can be disposed at any convenient position on the automobile and can be utilized by the engine without any alteration or modification to the original design of the automobile.

The invention will be further understood and additional objects and advantages will be apparent from a consideration of the ensuing description and drawings.

### SUMMARY OF THE INVENTION

This invention relates to a method for a fuel heating device regarding an internal combustion engine in an automobile for fuel efficiency and pollution reduction. The device is to improve the properties of a fuel prior to entrance into the combustion chambers of the engine. The device is performing a catalyzing process by a plurality of multi-elements plates and a multi-metallic layer to treat the fuel flowing from a fuel tank in the automobile throughout the device. The multi-elements plates are disposed within an inner chamber defined by a housing means for the device. The multi-metallic layer is on the outside surface of an infrared annular member in the center portion of the inner chamber. The multi-elements plates and the multi-metallic layer made of catalysis materials are performing the catalyzing process to promote the attributes of the fuel for efficient combustion in the chambers of the engine. Both are restoring the fuel back to original stage at refinery level before delivery to gas stations without bad influences of adding fuel additives. The device is performing a stabilizing process by a fuel stabilizer to treat the fuel flowing from the fuel tank in the automobile. The stabilizer disposed and attached on the inner wall of an inlet end is to regulate the amount and the pressure of the fuel to a constantly balancing level upon initial entrance into the device. The stabilizer is to avoid fuel supply waste in the chambers of the engine. The device is performing a magnetizing process by a fuel magnetizer to treat the fuel flowing from the fuel tank in the automobile throughout the device. The magnetizer disposed and attached on the inner wall of an outlet end is to magnetize the attributes of the fuel for enhancing fuel vaporization concerning efficiency improvement. The fuel treated is then to be delivered to the chambers of the engine of the automobile for combustion efficiency.

### BRIEF DESCRIPTION OF THE DRAWINGS

Additional objectives, features, and advantages of the present invention will be apparent from the following detailed description and appended claims in conjunction with accompanying drawings, and like reference numerals designate like parts and elements throughout all figures in the drawings, wherein FIG. 1 is a sectional view of a fuel heater device showing all principal parts in accordance with the present invention.

FIG. 2 is a sectional view of a fuel stabilizer showing all principal parts in accordance with the present invention.

FIG. 3 is an outline of an electrical system in accordance with the present invention. FIG. 4 are sectional and perspective views of two different embodiments for a fuel magnetizer and its two principal parts—an inner cylindrical magnetic member and an outer cylindrical magnetic member—in accordance with the present invention. FIG. 5 are three exploded views of one principal part—a tubular sleeve—for the preferred embodiment of the fuel magnetizer.

FIG. 6 are three exploded views of three principal parts—the inner cylindrical magnetic member, the outer cylindrical magnetic member, and a spacer ring—for the preferred embodiment of the fuel magnetizer.

FIG. 7 are orthogonal views of the fuel magnetizer in accordance with the present invention.

FIG. 8 are orthogonal views for the alternative embodiment of the fuel magnetizer.

### DETAILED DESCRIPTION OF THE PREFERRED EMBODIMENT

With particular reference to FIG. 1, a method for a fuel heating device 10 regarding an internal combustion engine (not shown) in an automobile (not shown) is to improve the properties of a fuel prior to entrance into the combustion chambers (not shown) of the engine in accordance with the preferred embodiment of this present invention. The device 10 is performing a catalyzing process by a plurality of multi-elements plates 38 and a multi-metallic layer 32, performing a stabilizing process by a fuel stabilizer 60, and performing a magnetizing process by a fuel magnetizer 80 to treat the fuel flowing from a fuel tank (not shown) in the automobile throughout the device 10. The device 10 is to promote the attributes of the fuel for efficient combustion in the chambers of the engine, to regulate the amount and the pressure of the fuel for avoidance of fuel supply waste in the chambers of the engine, and to magnetize the attributes of the fuel for enhancing fuel vaporization concerning efficiency improvement in the chambers of the engine. The device 10 then delivers the fuel treated to the chambers of the engine of the automobile for fuel efficiency and pollution reduction.

There is an infrared annular member 30 in the center portion of an inner chamber 15 between an inlet end 13 and an outlet end 14. The elongated annular member 30 can be divided into two different segments. The big segment is in small dimension at size 30A with its one side near the inlet end 13. The small segment is in large dimension at size 30B with its other side near the outlet end 14. The annular member 30, made of heat retaining materials, further has an interior passageway 16 to rapidly elevate and maintain the temperature of the fuel passing through from the inlet end 13. A housing means 12 mounted over a round base 40 is fixed securely by a plurality of installation holes 41 by means of fastening means (not shown) of screws and bolts.

Wrapping around the outside surface of the big segment in small dimension at size 30A of the annular member 30 near the inlet end 13, there is a spiral, electrical heating pipe 20. The heating pipe 20, made of heat conduction materials, safely enters into the housing means 12 from (an entering)/one position 21A near the inlet end 13 and safely exits out the housing means 12 from (an exiting)/another position 21B near the outlet end 14. Both the positions 21A and 21B of the heating pipe 20 are fixed and sealed safely with the housing means 12 by threaded engagements (not shown) to prevent unnecessary fuel leakages. The major purpose for the spiral heating pipe 20 to wrap around the outside surface of the annular member 30 near the inlet end 13 is to spread large contact region for the annular member 30 in order to promote heat conduction from the heating pipe 20 to the annular member 30. The minor purpose to wrap around the annular member 30 is to hold the annular member 30 in a firm and stable position within the inner chamber 15.

There are at least two or a plurality of sets of electrical heating elements 50, made of (positive temperature coefficient of) heat resistance materials and regulated by semiconductor controllers 56. All sets of the heating elements 50 are adjoined and touched together all the time to rapidly elevate the temperature of the heating pipe 20. All sets of the heating elements 50 are attached firmly on the inner wall of the heating pipe 20. For safety concern, all sets of the heating elements 50 are disposed within the heating pipe 20 to avoid any direct contact with the fuel passing through. All sets of the heating elements 50 are encircling extensively within the heating pipe 20 to spread large contact region for the heating pipe 20 in order to rapidly generate and conduct electrical heat. The reason for the heating pipe 20 made of heat conduction materials is to rapidly conduct the electrical heat from the heating pipe 20 to the annular member 30 and to filling metal gauzes 36. Both the heating elements 50 and the controllers 56 are connected with the battery and actuated by an ignition switch (not shown) in the automobile to deliver electrical current to the heating elements 50.

Besides the internal space of the heating pipe 20 occupied by the heating elements 50, other internal space of the heating pipe 20 is occupied with stuffing gauzes (not shown) made of magnesium oxide with heat-conduction and electricity-insulation in nature. The stuffing gauzes can insulate electrically all sets of the heating elements 50 and hold all sets of the heating elements 50 in their firm, stable, and respective positions. The stuffing gauzes also serve another function to evenly conduct the electrical heat from the heating elements 50 to the heating pipe 20 by means of direct contact via thermal conduction. The heating elements 50 and the stuffing gauzes both within the internal space of the heating pipe 20 can rapidly generate and evenly conduct the electrical heat from the heating elements 50 to the heating pipe 20 and can rapidly and evenly elevate the temperature of the heating pipe 20 via thermal conduction by means of direct contact with the heating pipe 20. On the outer surface of the heating pipe 20, there is sprayed with a nanometer-level ceramic coating 22 to prevent the fuel passing through in direct contact with the outer surface of the heating pipe 20 from overheating. The ceramic coating 22 practically works to lessen the extent of thermal conduction between the heating pipe 20 and the fuel passing through for safety concern. Likewise to the stuffing gauzes filled within the heating pipe 20 besides the heating elements 50, there are the multi-elements plates 38 and the filling metal gauzes 36 occupied within the internal room of the inner chamber 15 besides the annular member 30 and the heating pipe 20. The filling metal gauzes 36 can absorb heat diffused from the heating pipe 20 and the annular member 30. The filling metal gauzes 36 occupy most of the internal room of the inner chamber 15 and can hold the annular member 30 in a solid and stable position.

Three thermal exchangers of the heating pipe 20, the annular member 30 including the interior passageway 16, and the filling metal gauzes 36 are to exploit the electrical heat generated by the heating elements 50, to promote thermal conduction one another within the inner chamber 15 by means of direct and indirect contact via thermal conduction, and to rapidly elevate and maintain the temperature of the fuel passing through via thermal conduction by means of direct contact with the fuel. The heating elements 50 are to rapidly generate and conduct the electrical heat and to rapidly elevate the temperature of the heating pipe 20 by means of direct contact with the heating pipe 20 via thermal conduction. The heat/temperature of the heating pipe 20 is rapidly elevated via thermal conduction by means of direct contact with the heating elements 50. The heat/temperature of the annular member 30 is rapidly elevated via thermal conduction by means of direct contact with the heating pipe 20. The heat/temperature of the filling metal gauzes 36 is rapidly elevated via thermal conduction by means of direct and indirect contact with the heating pipe 20 and the annular member 30.

The heat/temperature from the electrical heating elements 50 is rapidly elevating the heat/temperatures of the three thermal exchangers, the heating pipe 20 and the annular member 30 including the interior passageway 16 and the filling metal gauzes 36 by means of direct and indirect contact via thermal conduction. The heat/temperature of the heating pipe 20 is rapidly elevating the heat/temperature of the annular member 30 and the heat/temperature of the interior passageway 16 by means of direct and indirect contact via thermal conduction. The heat/temperature of the heating pipe 20 and the heat/temperature of the annular member 30 are rapidly elevating the heat/temperature of the filling metal gauzes 36 by means of direct and indirect contact via thermal conduction. The heat/temperature of the heating pipe 20 and the heat/temperature of the annular member 30 including the interior passageway 16 and the heat/temperature of the filling metal gauzes 36 are rapidly elevating the temperature of the fuel via thermal conduction by means of direct contact with the fuel traveling throughout the inner chamber 15 from the inlet end 13 to the outlet end 14 to establish the flow path for the fuel to be elevated in the temperature of the fuel.

The annular member 30 made of heat retaining materials can maintain temperature stability within the inner chamber 15 by gradually releasing the retaining heat of the annular member 30 slowly. Throughout rapidly generating the electrical heat by the heating elements 50, evenly conducting the generating heat to the heating pipe 20 by the stuffing gauzes, rapidly conducting the generating heat to the fuel by the three thermal exchangers, and gradually releasing the retaining heat within the inner chamber 15 by the annular member 30, the device 10 is capable of having maintained the temperature stability within the inner chamber 15. Even after the ignition switch of the automobile is turned off, the annular member 30 can still maintain the temperature stability for a long period of time because of the heat retaining nature of the annular member 30.

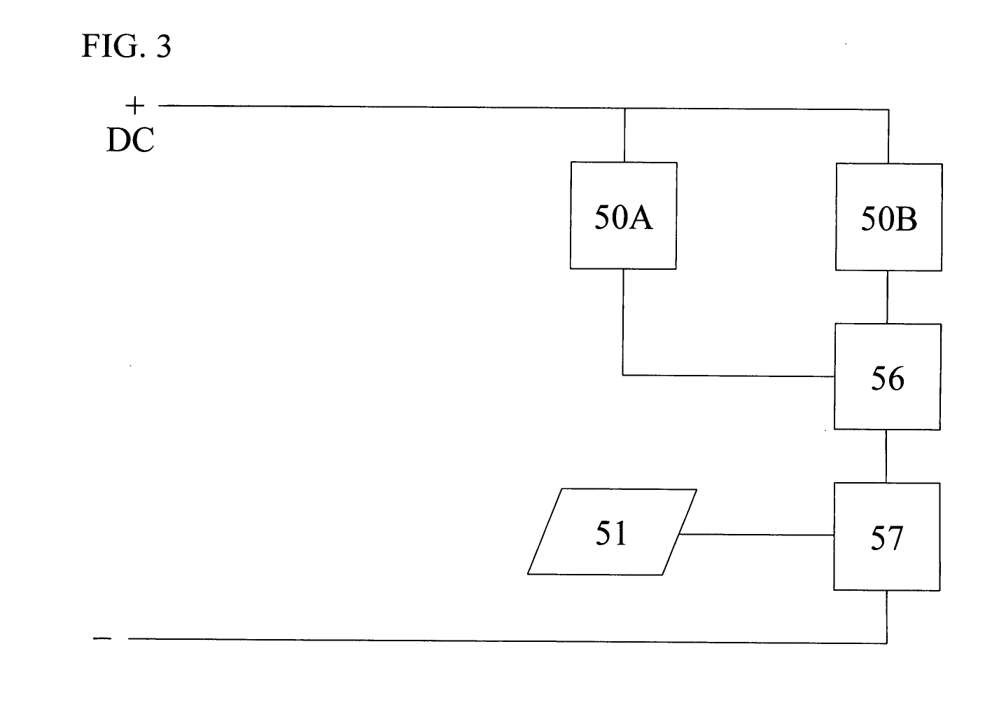

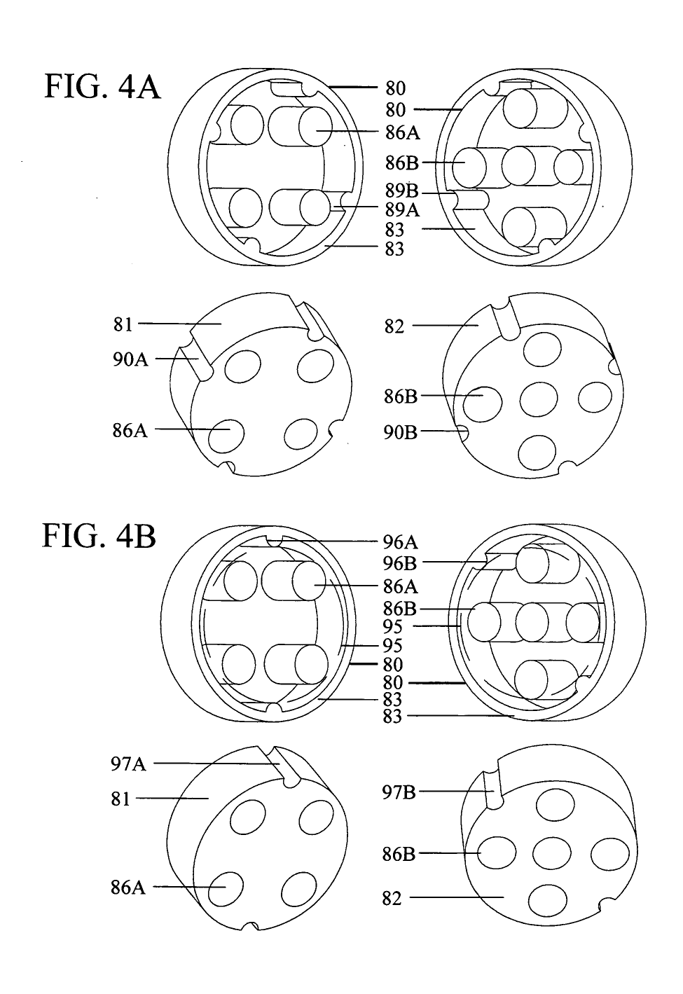

With particular reference to FIGS. 1 and 3, when the ignition switch of the automobile is turned on, a thermocouple probe 51 with two conductor wires enclosed within a sheath (not shown) at the advantageous junction 19 of the outlet end 14 is starting to constantly detect and monitor the temperature of the fuel. There are three reasons to explain why the temperature of the fuel within the inner chamber 15 is various instead of consistent: the temperature and the heat-generation extent of the electrical heat generated by the heating elements 50, the temperature and the heat-reception extent of the fuel received from the three thermal exchangers of the heating pipe 20 and the annular member 30 including the interior passageway 16 and the filling metal gauzes 36, and the flow paths of the fuel traveled through the inner chamber 15. Because of various differences among the three reasons, the temperatures and the extents of the fuel within the inner chamber 15 may be various and different.

In terms of the temperature and the heat-generation extent of the electrical heat generated by the heating elements 50, the temperature/extent is determined by how many sets of the heating elements 50 are activated by the controllers 56. In terms of the temperature and the heat-reception extent of the electrical heat generated by the heating elements 50, the heating pipe 20 of the thermal exchangers and the outside surface of the annular member 30 of the thermal exchangers receive maximum temperature/extent. The interior passageway 16 of the annular member 30 of the thermal exchangers receives medium temperature/extent. The filling metal gauzes 36 of the thermal exchangers receive minimum temperature/extent. In terms of the temperature and the heat-reception extent of the fuel, the maximum temperature/extent of the fuel is via thermal conduction by means of direct contact with the heating pipe 20 and the outside surface of the annular member 30. The medium temperature/extent of the fuel is via thermal conduction by means of direct contact with the interior passageway 16 of the annular member 30. The minimum temperature/extent of the fuel is via thermal conduction by means of direct contact solely with the filling metal gauzes 36.

There are two flow paths as the fuel enters into the device 10, travels through the inner chamber 15, and exits out the device 10. For both paths, the fuel enters into the device 10 from the inlet end 13 and exits out the device 10 from the outlet end 14. The variation between the two flow paths is the way of how the fuel travels through the inner chamber 15. For one path, the fuel travels through the inner chamber 15 via the interior passageway 16 of the annular member 30. For another path, the fuel travels through the inner chamber 15 via annular hollow 18 between the annular member 30 and the inner wall of the housing means 12. The latter fuel, which can be moreover subdivided into the fuel with different directions due to the design of the annular member 30, may carry various temperatures because of different heat-reception extents from the thermal exchangers. At the area 58 between the annular member 30 and the outlet end 14, all fuel with various the temperatures/extents from the different directions is converging and blending together to develop into a steady fuel with consistent temperature because of the design of the annular member 30 to greatly reduce cold and hot spots in the fuel for the device 10.

The fuel heating device 10 has the thermocouple probe 51 connected with the semiconductor controllers 56 and an integrated circuit 57 on a circuit board 55, and all further connected with the battery in the automobile before the fuel finally exits out the device 10. The thermocouple probe 51 is often detecting a lower temperature of the fuel at ambient surroundings especially in cold weather than a temperature range preset by optimum combustion for any type of fuels. The device 10 under the instruction of the integrated circuit 57 with the aid of the probe 51 instructs the controllers 56 to rapidly actuate all sets of the heating elements 50 to elevate the temperatures of the three thermal exchangers and the temperature of the fuel passing through. As soon as the probe 51 is detecting the temperature of the fuel reaching one degree Fahrenheit above the preset temperature range, the integrated circuit 57 instructs the controllers 56 to deactivate the other sets of the heating elements 50 for preventing the fuel from overheating. This only one set of the heating elements 50A not deactivated by the controllers 56 has been continually working to maintain the temperature of the fuel within the preset temperature range as long as the engine of the automobile is turned on. As soon as the probe 51 is detecting the temperature of the fuel dropping one degree Fahrenheit below the preset temperature range, the integrated circuit 57 instructs the controllers 56 to activate the heating elements 50B for elevating the temperature of the fuel again. The probe 51, the integrated circuit 57, and the controllers 56 all work together to rapidly/continually actuate, deactivate, and activate the heating elements 50 in order to comply with the preset temperature range in accordance with the temperature of the fuel detected by the probe 51.

On the outside surface of the annular member 30, there is sintered with the multi-metallic layer 32. The layer 32 is performing a catalyzing process to promote the attributes of the fuel for efficient combustion by restoring the fuel back to original stage at refinery level before delivery to gas stations without bad influences of adding fuel additives. The reason for the catalyzing process to promote the attributes of the fuel is that all refineries usually add additives to the fuel before delivery to gas stations for numerous reasons of safety, logistics, and antifreeze. Unfortunately, these additives are not helpful or even harmful for the fuel to be burned efficiently in the engine. To further promote the attributes of the fuel upon its initial entry into and final exit off the device 10, a plurality of the multi-elements plates 38, made of catalysis materials which are used often by refineries, may be disposed within the inner chamber 15 near the inlet end 13 or the outlet end 14. The multi-elements plates 38 are performing the catalyzing process to promote the attributes of the fuel for the efficient combustion by restoring the fuel back to the original stage at refinery level before delivery to gas stations without bad influences of adding fuel additives.

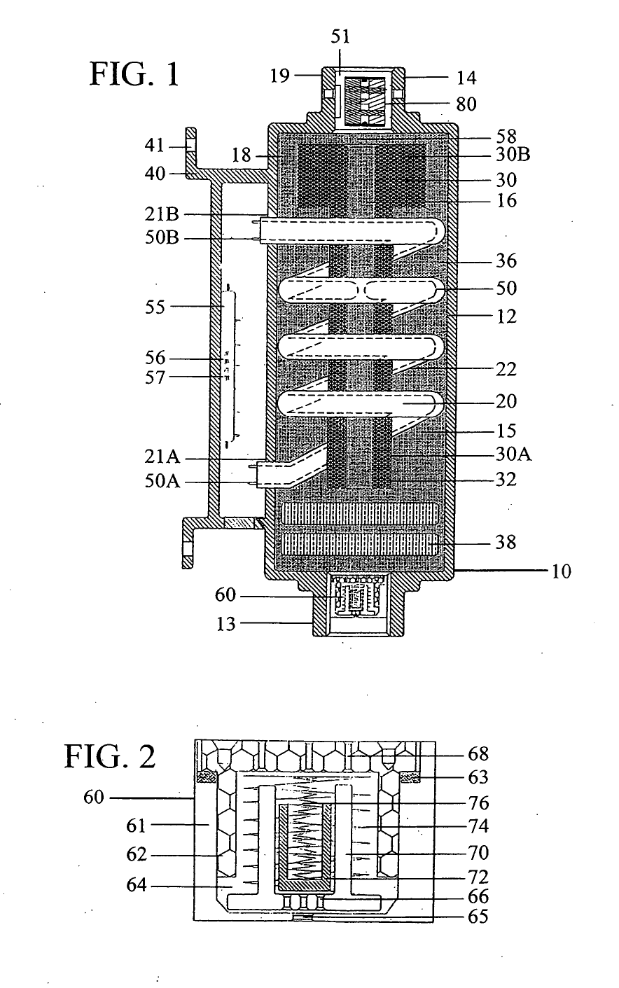

With particular reference to FIG. 2, a fuel stabilizer 60 disposed and attached on the inner wall of the inlet end 13 to regulate the amount and the pressure of the fuel flowing from the fuel tank in the automobile to a constantly balancing level upon initial entrance into the device 10. The stabilizer 60 is for avoidance of fuel supply waste in the combustion chambers of the engine. The stabilizer 60 comprises a cup-shaped inlet casing means 61 and a cup-shaped outlet casing means 62. Both are made of stiff materials and are disposed and attached on the inner wall of the inlet end 13 for the device 10. The cup-shaped inlet casing means 61 and the cup-shaped outlet casing means 62 are clamped 63 together to form an enclosure 64. The inlet casing means 61 further has an inlet orifice 65 in the center portion of the inlet casing means 61 normally to permit the fuel passing from the fuel tank to enter into the stabilizer 60. The outlet casing means 62 further has a plurality of outlet apertures 68 in the center portion of the outlet casing means 62 always to permit the fuel passing from the enclosure 64 to enter into the inner chamber 15 of the device 10.

In the enclosure 64, there is a u-shaped large piston 70. The bottom part of the large piston 70 is close and parallel to the inner wall of the inlet casing means 61. The large piston 70 has a plurality of inlet apertures 66 in the center portion of the large piston 70 normally to permit the fuel passing from the inlet orifice 65 to enter into the enclosure 64. Sometimes the large piston 70 may deny some flow passage of the fuel passing from the inlet orifice 65 to enter into the enclosure 64 when the large piston 70 is to perform a moving function toward the inlet casing means 61 to block some flow passage of the fuel passing from the inlet orifice 65 to enter into the enclosure 64. There is a large compression spring 74 disposed and extended between the large piston 70 and the outlet casing means 62. One side of the compression spring 74 is attached to the inner wall of the large piston 70, whereas the other side of the compression spring 74 is attached to the inner wall of the outlet casing means 62. The compression spring 74 is to provide a restraining force to push the large piston 70 toward the inlet casing means 61.

There is also a u-shaped small piston 72 disposed in the pocket of the large piston 70 in the enclosure 64. The bottom part of the small piston 72 is close and parallel to the bottom part of the large piston 70. The small piston 72 is normally to permit the fuel passing from the inlet apertures 66 to enter into the enclosure 64. Sometimes the small piston 72 may deny some flow passage of the fuel passing from the inlet apertures 66 to enter into the enclosure 64 when the small piston 72 is to perform a moving function toward the large piston 70 to block some flow passage of the fuel passing from the inlet apertures 66 to enter into the enclosure 64. There is a small tension spring 76 disposed and extended between the small piston 72 and the outlet casing means 62. One side of the tension spring 76 is attached to the inner wall of the small piston 72, whereas the other side of the tension spring 76 is attached to the inner wall of the outlet casing means 62. The tension spring 76 is to provide a restraining force to push the small piston 72 toward the large piston 70. The stabilizer 60 is utilizing the restraining force of the compression spring 74 and the restraining force of the tension spring 76 in accompanying with the moving function of the large piston 70 and the moving function of the small piston 72 to block some flow passage of the fuel in order to achieve the constantly balancing level for the amount and the pressure of the fuel passing through for the avoidance of the fuel supply waste in the chambers of the engine.

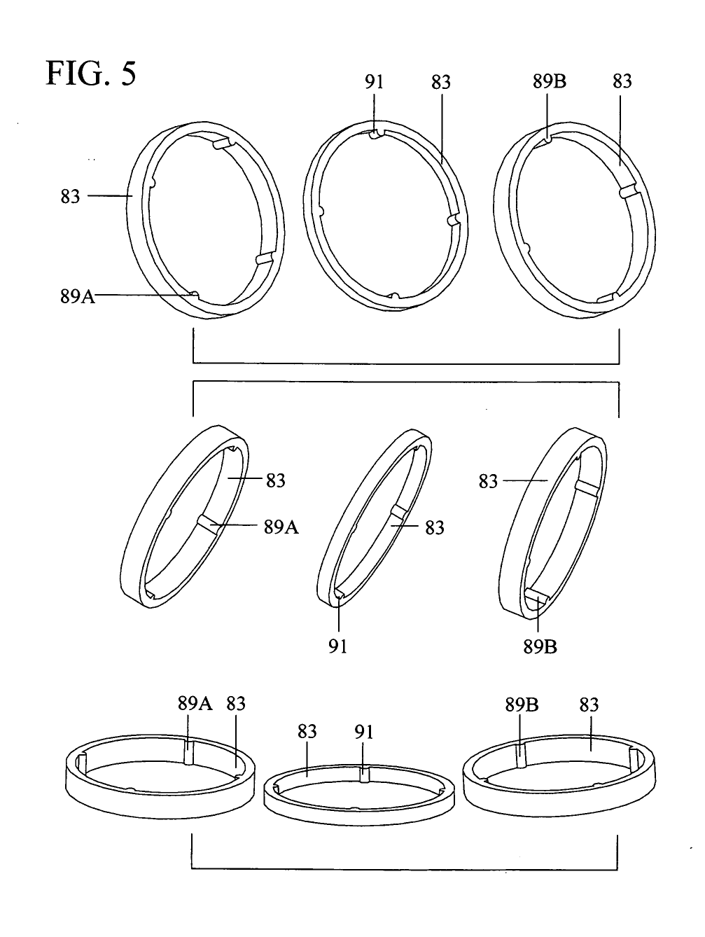

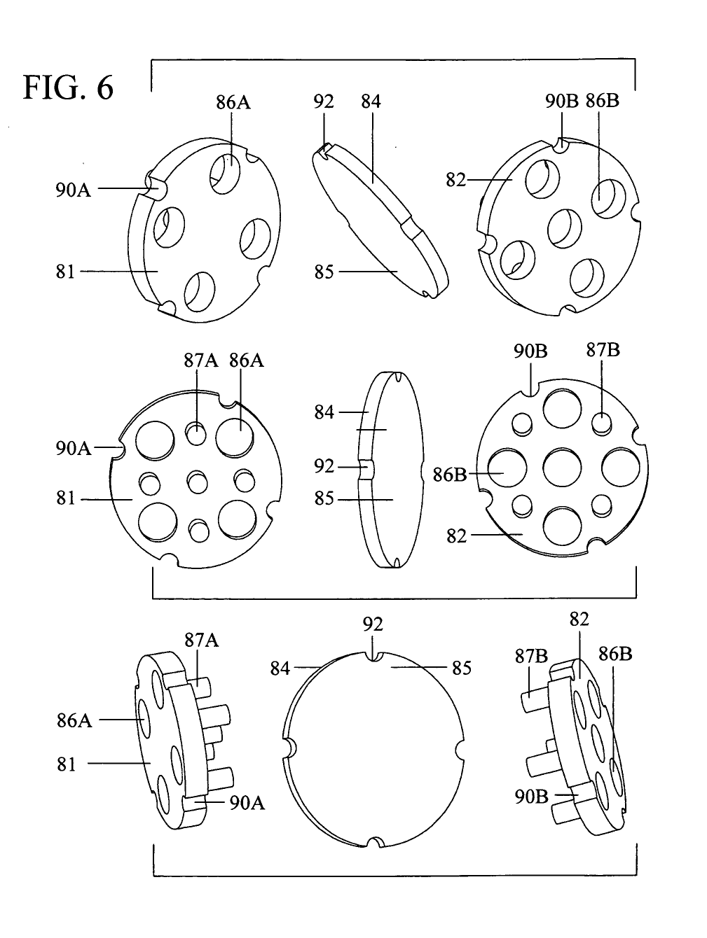

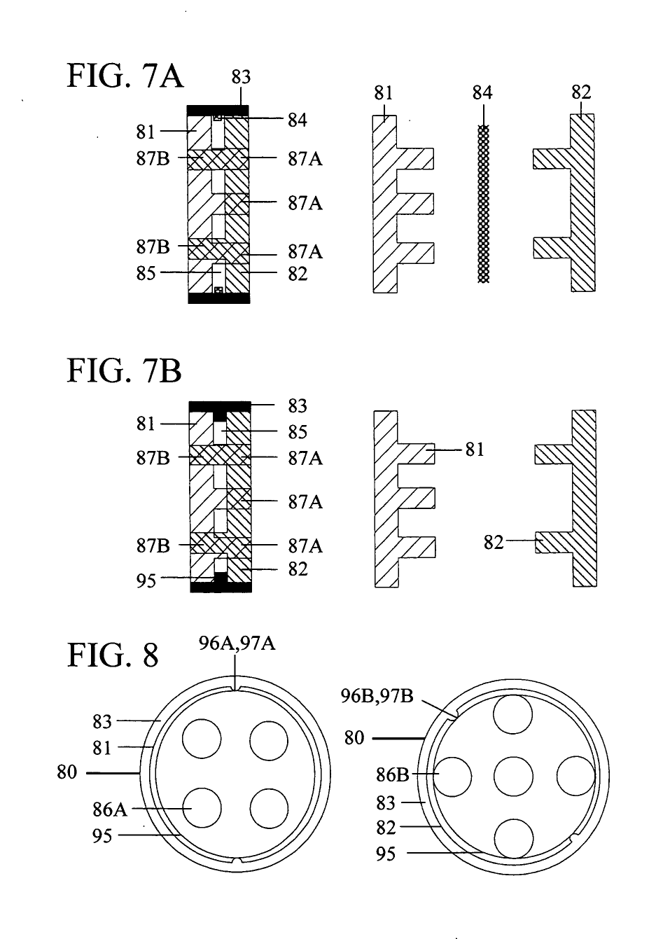

With particular reference to FIGS. 4A, 5, 6, 7A, and 8, a fuel magnetizer 80 is to magnetize the attributes of the fuel passing from the inner chamber 15 for enhancing fuel vaporization concerning efficiency improvement. The magnetizer 80 is disposed and attached on the inner wall of the outlet end 14 of the device 10. The magnetizer 80 comprises an outer cylindrical magnetic member 81, an inner cylindrical magnetic member 82, a tubular sleeve 83, and a spacer ring 84. With regard to the disposition, the inner magnetic member 82 is closer to the annular member 30 than the outer magnetic member 31. Both the outer magnetic members 81 and the inner magnetic members 82 are made of Nd—Fe—B permanent magnet, whereas the tubular sleeve 83 and the spacer ring 84 are fuel resistance materials.

The outer magnetic member 81 has four keyways 90A around the external cylindrical surface of the outer magnetic member 81 to be inserted into by four respective splines 89A of the tubular sleeve 83 correspondingly. The inner magnetic member 82 has four keyways 90B around the external cylindrical surface of the inner magnetic member 82 to be inserted into by four respective splines 89B of the tubular sleeve 83 correspondingly. The outer magnetic member 81 has four round passage holes 86A to allow the fuel to exit out the magnetizer 80 and five cylinder projections 87A to extend into the corresponding round passage holes 86B of the inner magnetic member 82 to create magnetic fields within the passage holes 86B. The inner magnetic member 82 has five round passage holes 86B to allow the fuel to enter into the magnetizer 80 and four cylinder projections 87B to extend into the corresponding round passage holes 86A of the outer magnetic member 81 to create magnetic fields within the passage holes 86A. The identical diameter of each round passage hole 86 in terms of length is exactly twice long as the identical diameter of each cylinder projection 87 for both the outer magnetic member 81 and the inner magnetic member 82.

The tubular sleeve 83 has four respective splines 91 over the center portion of the internal surface of the tubular sleeve 83 to insert into four keyways 92 of the spacer ring 84. The tubular sleeve 83 has four respective splines 89A over one side of the internal surface of the tubular sleeve 83 to insert into the keyways of the outer magnetic member 81 correspondingly. The tubular sleeve 83 has four respective splines 89B over other side of the internal surface of the tubular sleeve 83 to insert into the keyways of the inner magnetic member 82 correspondingly.

The spacer ring 84 disposed in the center portion of the magnetizer 80 has four keyways 92 around the external ring surface of the spacer ring 84 to allow respective the splines over the center portion of the internal surface of the tubular sleeve 83 to be inserted into. The spacer ring 84 is to separate the outer magnetic member 81 from the inner magnetic member 82 for defining a cavity 85 with a magnetic field within the cavity 85 because of Nd—Fe—B permanent magnet. The cavity 85 between the outer magnetic member 81 and the inner magnetic member 82 is to provide excessive fuel flowing from the inner magnetic member 82 to be accumulated and to be treated there by a magnetic field generated by the Nd—Fe—B permanent magnet prior to entrance into the outer magnetic member 81.

The magnetizer 80 utilizes the splines 89 and 91 and the keyways 90 and 92 to hold the tubular sleeve 83, the spacer ring 84, the outer magnetic members 81, and the inner magnetic members 82 as a cohesive unit. The magnetic fields within the passage holes 86B of the outer magnetic member 81, the cavity 85, and the passage holes 86A of the inner magnetic member 82 develop a magnetic flow path throughout the magnetizer 80 for enhancing the fuel vaporization concerning the efficiency improvement.

The thermocouple probe 51 at the advantageous junction 19 of the outlet end 14 is constantly detecting and monitoring the temperature of the fuel by means of direct contact with the fuel as long as the engine of the automobile is turned on. The probe 51 at the advantageous junction 19 of the outlet end 14 is constantly converting the temperature of the fuel into an electronic signal to be sent to the integrated circuit 57 as long as the engine of the automobile is turned on. The probe 51 at the advantageous junction 19 of the outlet end 14 with the aid of the integrated circuit 57 is also constantly monitoring the temperature of the fuel to determine whether the temperature of the fuel is within the preset temperature range or not as long as the engine of the automobile is turned on. The probe 51 at the advantageous junction 19 of the outlet end 14 is constantly/continually repeating the detecting function and the monitoring function unless the engine of the automobile is turned off.

The semiconductor controllers 56 on the circuit board 55 are rapidly activating and deactivating the heating elements 50 and continually repeating the activating function and the deactivating function as long as the engine of the automobile is turned on. If the probe 51 at the advantageous junction 19 of the outlet end 14 is detecting the temperature of the fuel below the preset temperature range, the controllers 56 on the circuit board 55 will rapidly activate the heating elements 50 as long as the engine of the automobile is turned on. If the probe 51 at the advantageous junction 19 of the outlet end 14 is detecting the temperature of the fuel above the preset temperature range, the controllers 56 on the circuit board 55 will rapidly deactivate the heating elements 50 as long as the engine of the automobile is turned on. The controllers 56 on the circuit board 55 are rapidly/continually repeating the activating function and the deactivating function unless the engine of the automobile is turned off.

The thermocouple probe 51 at the advantageous junction 19 of the outlet end 14 is constantly/continually detecting and monitoring the temperature of the fuel and the semiconductor controllers 56 on the circuit board 55 are rapidly/continually activating and deactivating the heating elements 50 to lessen, elevate, and maintain the temperature of the fuel as long as the engine of the automobile is turned on. The controllers 56 are rapidly actuating all sets of the heating elements 50 to elevate the temperature of the fuel as soon as the ignition switch of the automobile is started. If the probe 51 is detecting the temperature of the fuel above the preset temperature range, the controllers 56 will rapidly deactivate all sets except one set or other sets of the heating elements 50 to lessen/maintain the temperature of the fuel within the preset temperature range as long as the engine of the automobile is turned on. The only one set of the heating elements 50 has been continually working to prevent the temperature of the fuel dropping below the preset temperature range unless the engine of the automobile is turned off If the probe 51 is detecting the temperature of the fuel below the preset temperature range, the controllers 56 will rapidly activate the other sets of the heating elements 50 to elevate/maintain the temperature of the fuel again within the preset temperature range as long as the engine of the automobile is turned on. The controllers 56 are rapidly/continually repeating the deactivating function to lessen/maintain and rapidly/continually repeating the activating function to elevate/maintain the temperature of the fuel within the preset temperature range unless the engine of the automobile is turned off.

The thermocouple probe 51 at the advantageous junction 19 of the outlet end 14 is constantly/continually detecting and monitoring the temperature of the fuel and the semiconductor controllers 56 and the integrated circuit 57 on the circuit board 55 are rapidly/continually activating and deactivating the heating elements 50 to lessen, elevate, and maintain the temperature of the fuel as long as the engine of the automobile is turned on. The controllers 56 and the integrated circuit 57 on the circuit board 55 are continually elevating the temperature of the fuel by means of activating rapidly and maintaining continually the other sets of the heating elements 50 unless the probe 51 is detecting the temperature of the fuel above the preset temperature range. The probe 51, the controllers 56, and the integrated circuit 57 of the device 10 are repeating constantly/continually the detecting function and the monitoring function and repeating rapidly/continually the activating function and the deactivating function and the elevating function to lessen, elevate, and maintain the temperature of the fuel within the preset temperature range unless the engine of the automobile is turned off. The device 10 under the instruction of the integrated circuit 57 with aid of the probe 51 instructs the controllers 56 to activate and deactivate the heating elements 50 and to lessen, elevate, and maintain the temperature of the fuel passing through. These functions performed by the three instruments above as a whole consequently result into two favorable effects: fuel efficiency and pollution reduction.

By strategically selecting the advantageous junction 19 at the outlet end 14 for the thermocouple probe 51 to constantly detect and monitor the temperature of the fuel passing through the inner chamber 15 defined by the housing means 12 before the fuel finally exits out the device 10, any person may agree that the detected temperature of the fuel should rightfully represent the true temperature of the fuel for the device 10. According to the reasoning, the device 10 intelligently adopts the detected temperature of the fuel at the advantageous junction 19 of the outlet end 14 as the temperature of the fuel, a yardstick for the controllers 56 under the instruction of the integrated circuit 57 with the aid of the probe 51 to rapidly actuate, deactivate, and activate each set of the heating elements 50 respectively.

In another embodiment shown in FIGS. 4B, 7B, and 8, an alternative fuel magnetizer 80 disposed and attached on the inner wall of the outlet end 14 is to magnetize the attributes of the fuel passing from the inner chamber 15 for enhancing fuel vaporization concerning efficiency improvement. The magnetizer 80 comprises an outer cylindrical magnetic member 81, an inner cylindrical magnetic member 82, and a tubular sleeve 83. With regard to the disposition, the inner magnetic member 82 is closer to the annular member 30 than the outer magnetic member 81. Both the outer magnetic member 81 and the inner magnetic member 82 are made of Nd—Fe—B permanent magnet, whereas the tubular sleeve 83 is made of fuel resistance materials.

The outer magnetic member 81 has four keyways 90A around the external cylindrical surface of the outer magnetic member 81 to be inserted into by four respective splines 89A of the tubular sleeve 83 correspondingly. The inner magnetic member 82 has four keyways 90B around the external cylindrical surface of the inner magnetic member 82 to be inserted into by four respective splines 89B of the tubular sleeve 83 correspondingly. The outer magnetic member 81 has four round passage holes 86A to allow the fuel to exit out the magnetizer 80 and five cylinder projections 87A to extend into the corresponding round passage holes 86B of the inner magnetic member 82 to create magnetic fields within the passage holes 86B. The inner magnetic member 82 has five round passage holes 86B to allow the fuel to enter into the magnetizer 80 and four cylinder projections 87B to extend into the corresponding round passage holes 86A of the outer magnetic member 81 to create magnetic fields within the passage holes 86A. The identical diameter of each round passage hole 86 in terms of length is exactly twice long as the identical diameter of each cylinder projection 87 for both the outer magnetic member 81 and the inner magnetic member 82.

The tubular sleeve 83 has an attached annulus 95 over the center portion of the internal surface of the tubular sleeve 83. The tubular sleeve 83 has two respective splines 89A over one side of the internal surface of the tubular sleeve 83 to insert into the keyways of the outer magnetic member 81 correspondingly. The tubular sleeve 83 has two respective splines 89B over other side of the internal surface of the tubular sleeve 83 to insert into the keyways of the inner magnetic member 82 correspondingly. The annulus 95 is for separating the outer magnetic member 81 from the inner magnetic member 82 to define a cavity 85 with a magnetic field within the cavity 85 because of Nd—Fe—B permanent magnet. The annulus 95 is extending from the internal surface of the tubular sleeve 83 into the cavity 85. The cavity 85 between the outer magnetic member 81 and the inner magnetic member 82 provides excessive fuel flowing from the inner magnetic member 82 to be accumulated and to be treated there by a magnetic field generated by the Nd—Fe—B permanent magnet prior to entrance into the outer magnetic member 81.

The magnetizer 80 utilizes the splines 96A and 96B and keyways 97A and 97B to hold the tubular sleeve 83, the outer magnetic member 81, and the inner magnetic member 82 as a cohesive unit. The magnetic fields within the passage holes 86B of the outer magnetic member 81, the cavity 85, and the passage holes 86A of the inner magnetic member 82 develop a magnetic flow path throughout the magnetizer 80 for enhancing the fuel vaporization concerning the efficiency improvement.

Both the circuit board 55 and the housing means 12 are mounted over the holding base 40 on the automobile. The fuel heating device 10 is suitable for all types of fuels: regular gasoline, premium gasoline, ethanol gasoline, methanol gasoline, diesel fuel, emulsified fuel, and composite fuel. Each type of the fuels has its own preset temperature range for the efficient combustion in the engine.

In conclusion, the fuel heating device 10 is to elevate and maintain the temperature of the fuel and to improve the properties of the fuel flowing via the fuel pipe from the fuel tank in the automobile prior to entrance into the combustion chambers of the internal combustion engine in the automobile. The device 10 comprises the built-in fuel stabilizer 60, the nanometer-level ceramic coating 22, the multi-elements plates 38, the multi-metallic layer 32, the three thermal exchangers, the built-in fuel magnetizer 80, and an electrical system. The stabilizer 60 disposed at the inlet end 13 is regulating the amount and the pressure of the fuel to the constantly balancing level upon initial entrance into the device 10 for the avoidance of the fuel supply waste in the chambers of the engine. The nanometer-level ceramic coating 22 of the heating pipe 20 is preventing the fuel passing through in direct contact with the outer surface of the heating pipe 20 from overheating. The multi-elements plates 38 within the inner chamber 15 and the multi-metallic layer 32 on the outside surface of the annular member 30 are performing the catalyzing process to promote the attributes of the fuel for the efficient combustion. Both are restoring the fuel back to the original stage at refinery level before delivery to gas stations without bad influences of adding fuel additives. The three thermal exchangers of the heating pipe 20 and the annular member 30 and the filling metal gauzes 36 including the interior passageway 16 of the annular member 30 are rapidly/continually elevating and maintaining the temperature of the fuel via thermal conduction by means of direct contact with the fuel passing through for fuel efficiency and pollution reduction. The three thermal exchangers are to receive and conduct the electrical heat generated by at least two sets of the electrical heating elements 50 within the internal space of the heating pipe 20. Because of the heat retaining nature, the annular member 30 is capable of having maintained the temperature stability within the inner chamber 15. Even for a long period of time after the ignition switch of the automobile is turned off, the annular member 30 can still maintain the temperature stability by gradually releasing the retaining heat slowly. The magnetizer 80 disposed at the outlet end 14 is magnetizing the attributes of the fuel for enhancing the fuel vaporization concerning the efficiency improvement.

The thermocouple probe 51 of the electrical system is constantly/continually detecting and monitoring the temperature of the fuel at the advantageous junction 19 of the outlet end 14. All fuel at the advantageous junction 19 of the outlet end 14, passing through the inner chamber 15 before the fuel finally exits out the device 10, with various the temperatures/extents from the different directions is converging and blending into the steady fuel with the consistent temperature. Because of the design of the magnetizer 80, the device 10 throughout the converging and blending process is able to greatly reduce the cold and hot spots in the fuel. The semiconductor controllers 56 of the electrical system are rapidly/continually activating and deactivating all sets except one set of the heating elements 50. The one set of the heating elements 50 has been working continually to maintain the temperature of the fuel as long as the ignition switch of the automobile is turned on. The device 10 is intelligently adopting the detected temperature of the fuel as the true temperature of the fuel. The probe 51 with the aid of the integrated circuit 57 of the electrical system is determining whether the temperature of the fuel is within the preset temperature range. The controllers 56 under the instruction of the integrated circuit 57 are utilizing the temperature of the fuel as a yardstick to rapidly actuate, deactivate, and activate each set of the heating elements 50 respectively.

### OPERATION OF THE INVENTION

The preferred embodiment of a method for a fuel heating device 10 regarding an internal combustion engine (not shown) in an automobile (not shown) is performing a catalyzing process by a plurality of multi-elements plates 38 and a multi-metallic layer 32, performing a stabilizing process by a fuel stabilizer 60, and performing a magnetizing process by a fuel magnetizer 80. The device 10 is to treat a fuel flowing from a fuel tank (not shown) in the automobile throughout the device 10 in order to improve the properties of the fuel prior to entrance into the combustion chambers (not shown) of the engine. The device 10 is to promote the attributes of the fuel for efficient combustion in the chambers of the engine, to regulate the amount and the pressure of the fuel for avoidance of fuel supply waste in the chambers of the engine, and to magnetize the attributes of the fuel for enhancing fuel vaporization concerning efficiency improvement in the chambers of the engine. The device 10 then delivers the fuel treated to the chambers of the engine of the automobile for fuel efficiency and pollution reduction. The device 10 and the method described and depicted above can be moreover delineated from the angles of both of the operations of the device 10 and the processes of the method.

When an ignition switch (not shown) in the automobile is turned on, a battery (not shown) in the automobile is to provide the device 10 with electrical current to all sets of electrical heating elements 50. There are at least two or a plurality of sets of the electrical heating elements 50 made of heat resistance materials and regulated by semiconductor controllers 56. All sets of the heating elements 50 are adjoined and touched together all the time and attached firmly on the inner wall of a spiral, electrical heating pipe 20. Each set of the heating elements 50 is encircling extensively within the internal room of the heating Pipe 20 to spread large contact region for the heating pipe 20. The heating elements 50 are to rapidly generate and conduct the electrical heat for rapidly elevating the temperature of the heating pipe 20 by means of direct contact with the heating pipe 20 via thermal conduction.

An infrared annular member 30 is in the center portion of an inner chamber 15 defined by a housing means 12 for the device 10. The infrared annular member 30 is elongated in shape and made of heat retaining materials. The annular member 30 having an interior passageway 16 is to rapidly elevate the temperature of the fuel passing through from the inlet end 13 by means of direct contact via thermal conduction. The annular member 30 can maintain temperature stability within the inner chamber 15 by gradually releasing the retaining heat of the annular member 30 slowly. Wrapping around the outside surface of the annular member 30 near the inlet end 13, there is the spiral heating pipe 20.

The housing means 12 made of rigid materials defines the inner chamber 15 in the middle with an inlet end 13 at one side and with an outlet end 14 at other side. The inlet end 13 is connected with a fuel pipe (not shown) from the fuel tank and the outlet end 14 is connected with the engine with the device 10 in between. The fuel heating device 10 utilizes the housing means 12 to establish a flow path for the fuel traveling throughout the inner chamber 15 from the inlet end 13 to the outlet end 14 to elevate the temperature of the fuel and to improve the properties of the fuel for the efficient combustion.

The device 10 is to promote the attributes of the fuel by sintering the multi-metallic layer 32 on the outside surface of the annular member 30 and by providing the multi-elements plates 38 within the inner chamber 15. Both made of catalysis materials are performing the catalyzing process for the efficient combustion in the chambers of the engine by restoring the fuel back to original stage at refinery level before delivery to gas stations without bad influences of adding fuel additives. On the outer surface of the heating pipe 20, there is sprayed with a nanometer-level ceramic coating 22 to lessen the extent of thermal conduction between the heating pipe 20 and the fuel passing through for safety concern and to prevent the fuel passing through in direct contact with the outer surface of the heating pipe 20 from overheating.

The device 10 provides the fuel stabilizer 60 disposed and attached on the inner wall of the inlet end 13. The stabilizer 60 is performing the stabilizing process to a constantly balancing level upon initial entrance into the device 10. The stabilizer 60 is to regulate the amount and the pressure of the fuel flowing from the fuel tank in the automobile for the avoidance of the fuel supply waste in the combustion chambers of the engine. The fuel heating device 10 also provides the fuel magnetizer 80 or an alternative fuel magnetizer 80 disposed and attached on the inner wall of the outlet end 14. The magnetizer 80 is performing the magnetizing process to magnetize the attributes of the fuel passing from the inner chamber 15 for enhancing the fuel vaporization concerning the efficiency improvement.

All fuel at the advantageous junction 19 of the outlet end 14 with various temperatures from different directions is converging and blending together to develop into a steady fuel with consistent temperature. Because of the design of the annular member 30 and the magnetizer 80, the device 10 is able to greatly reduce cold and hot spots in the fuel for the device 10. A thermocouple probe 51 at the advantageous junction 19 of the outlet end 14 is constantly detecting the consistent temperature of the steady fuel by means of direct contact with the fuel as long as the engine of the automobile is turned on. The probe 51 at the advantageous junction 19 of the outlet end 14 is constantly converting the temperature of the fuel into an electronic signal to be sent to an integrated circuit 57 as long as the engine of the automobile is turned on. The probe 51 at the advantageous junction 19 of the outlet end 14 with the aid of the integrated circuit 57 is constantly monitoring the temperature of the fuel to determine whether the temperature of the fuel is within a preset temperature range or not as long as the engine of the automobile is turned on. The probe 51 at the advantageous junction 19 of the outlet end 14 is constantly/continually repeating the detecting function and the monitoring function unless the engine of the automobile is turned off.

By strategically selecting the advantageous junction 19 of the outlet end 14 for the thermocouple probe 51 to constantly detect the temperature of the fuel passing through the inner chamber 15 before the fuel finally exits out the device 10, any person may agree that the detected temperature of the fuel should rightfully represent the true temperature of the fuel for the device 10. According to this reasoning, the device 10 is intelligently adopting the detected temperature of the fuel at the advantageous junction 19 of the outlet end 14 as the temperature of the fuel, a yardstick for the controllers 56 under the instruction of the integrated circuit 57 with the aid of the probe 51 to rapidly actuate, deactivate, and activate each set of the electrical heating elements 50 respectively.

When the fuel initially flows into the device 10, the built-in fuel stabilizer 60 at the inlet end 13 is treating the fuel passing through to the constantly balancing level by means of direct contact. The amount and the pressure of the fuel are regulated by the stabilizer 60 for the avoidance of the fuel supply waste in the chambers of the engine. When the fuel flows into the inner chamber 15, the multi-elements plates 38 and the multi-metallic layer 32 are treating the fuel passing through by means of direct contact. The attributes of the fuel are promoted by the multi-elements plates 38 and the multi-metallic layer 32 for the efficient combustion in the chambers of the engine. When the fuel flows through the inner chamber 15, the built-in fuel magnetizer 80 at the outlet end 14 is magnetizing the fuel passing through by means of direct contact. The attributes of the fuel tare magnetized by the magnetizer 80 for enhancing the fuel vaporization concerning the efficiency improvement in the chambers of the engine. The properties of the fuel are improved by the catalyzing process, the stabilizing process, and the magnetizing process. The fuel treated is then to be delivered to the chambers of the engine of the automobile for the efficient combustion.

Accordingly, while this invention has been described with reference to the illustrative embodiment, none should intend to interpret the description in a limiting or narrow sense regarding its scope. Various ramifications, variations, and modifications of the illustrative embodiment will be apparent to those people skilled in the art upon reference to the description. It is therefore contemplated that the appended claims and their legal equivalents will cover any aforesaid ramifications, variations, and modifications within the true scope of the invention.

I claim:

1. A method for a fuel heating device regarding an internal combustion engine in an automobile is to improve the properties of a fuel prior to entrance into the combustion chambers of said engine for fuel efficiency and pollution reduction, comprising the processes of:
a) performing a catalyzing process to treat said fuel by a plurality of multi-elements plates and a multi-metallic layer;
b) performing a stabilizing process to treat said fuel by a fuel stabilizer; and
c) performing a magnetizing process to treat said fuel by a fuel magnetizer,
whereby said device performing said catalyzing process to promote the attributes of said fuel for efficient combustion in said chambers of said engine, performing said stabilizing process to regulate the amount and the pressure of said fuel for avoidance of fuel supply waste in said chambers of said engine, and performing said magnetizing process to magnetize said attributes of said fuel for enhancing fuel vaporization concerning efficiency improvement in said chambers of said engine to treat said fuel flowing from a fuel tank in said automobile throughout said device.

2. The method of claim 1, wherein said multi-elements plates being disposed within an inner chamber defined by a housing means in said device and said multi-metallic layer being sintered on the outside surface of an infrared annular member in the center portion of said inner chamber, both performing said catalyzing process to promote said attributes of said fuel for said efficient combustion in said chambers of said engine by restoring said fuel back to original stage at refinery level before delivery to gas stations without bad influences of adding fuel additives.

3. The method of claim 1, wherein said fuel stabilizer, being disposed and attached on the inner wall of an inlet end defined by a housing means in said device, performing said stabilizing process to regulate said amount and said pressure of said fuel flowing from said fuel tank in said automobile to a constantly balancing level upon initial entrance into said device, comprising:
a) a cup-shaped inlet casing means and a cup-shaped outlet casing means, both being made of stiff materials and being disposed and attached on said inner wall of said inlet end and being clamped together to form an enclosure, said inlet casing means further having an inlet orifice in the center portion of said inlet casing means normally to permit said fuel passing from said fuel tank to enter into said stabilizer, and said outlet casing means further having a plurality of outlet apertures in the center portion of said outlet casing means always to permit said fuel passing from said enclosure to enter into said inner chamber of said device;
b) a u-shaped large piston in said enclosure, the bottom part of said large piston being close and parallel to the inner wall of said inlet casing means, said large piston having a plurality of inlet apertures in the center portion of said large piston normally to permit said fuel passing from said inlet orifice to enter into said enclosure and said large piston sometimes to deny some flow passage of said fuel passing from said inlet orifice to enter into said enclosure when said large piston is to perform a moving function toward said inlet casing means to block some flow passage of said fuel passing from said inlet orifice to enter into said enclosure;
c) a large compression spring, being disposed and extended between said large piston and said outlet casing means, one side of said compression spring being attached to the inner wall of said large piston, whereas the other side of said compression spring being attached to the inner wall of said outlet casing means to provide a restraining force to push said large piston toward said inlet casing means;
d) a u-shaped small piston in said enclosure being disposed in the pocket of said large piston, the bottom part of said small piston being close and parallel to said bottom part of said large piston, and said small piston being normally to permit said fuel passing from said inlet apertures to enter into said enclosure and said small piston sometimes to deny some flow passage of said fuel passing from said inlet apertures to enter into said enclosure when said small piston is to perform a moving function toward said large piston to block some flow passage of said fuel passing from said inlet apertures to enter into said enclosure; and
e) a small tension spring being disposed and extended between said small piston and said outlet casing means, one side of said tension spring being attached to the inner wall of said small piston, whereas the other side of said tension spring being attached to said inner wall of said outlet casing means to provide a restraining force to push said small piston toward said large piston,
whereby said fuel stabilizer utilizing said restraining force of said compression spring and said restraining force of said tension spring in accompanying with said moving function of said large piston and said moving function of said small piston to block some flow passage of said fuel for said avoidance of said fuel supply waste in said chambers of said engine.

4. The method of claim 1, wherein said fuel magnetizer, being disposed and attached on the inner wall of an outlet end defined by a housing means in said device, performing said magnetizing process to magnetize said attributes of said fuel passing from an inner chamber defined by said housing means, comprising:
a) an outer cylindrical magnetic member having a plurality of keyways around the external cylindrical surface of said outer magnetic member to be inserted into by a plurality of respective splines of a tubular sleeve correspondingly and an inner cylindrical magnetic member having a plurality of keyways around the external cylindrical surface of said inner magnetic member to be inserted into by a plurality of respective splines of said tubular sleeve correspondingly, both said outer magnetic member and said inner magnetic member being made of Nd—Fe—B permanent magnet, and said outer magnetic member having a plurality of round passage holes to allow said fuel to exit out said magnetizer and a plurality of cylinder projections to extend into the corresponding round passage holes of said inner magnetic member to create magnetic fields within said passage holes and said inner magnetic member having a plurality of round passage holes to allow said fuel to enter into said magnetizer and a plurality of cylinder projections to extend into the corresponding said round passage holes of said outer magnetic member to create magnetic fields within said passage holes;
b) said tubular sleeve made of fuel resistance materials having a plurality of respective splines over the center portion of the internal surface of said tubular sleeve to insert into a plurality of keyways of a spacer ring, having a plurality of respective splines over one side of said internal surface of said tubular sleeve to insert into said keyways of said outer magnetic member correspondingly, and having a plurality of respective splines over other side of said internal surface of said tubular sleeve to insert into said keyways of said inner magnetic member correspondingly; and
c) said spacer ring made of said fuel resistance materials and disposed in the center portion of said magnetizer, having a plurality of keyways around the external ring surface of said spacer ring to allow respective said splines over said center portion of said internal surface of said tubular sleeve to be inserted into, separating said outer magnetic member from said inner magnetic member for defining a cavity with a magnetic field within said cavity because of Nd—Fe—B permanent magnet, and said cavity between said outer magnetic member and said inner magnetic member providing excessive fuel flowing from said inner magnetic member to be accumulated and to be treated there by a magnetic field generated by said Nd—Fe—B permanent magnet prior to entrance into said outer magnetic member,
whereby said fuel magnetizer utilizing said splines and said keyways to hold said tubular sleeve, said spacer ring, said outer magnetic members, and said inner magnetic members as a cohesive unit and said magnetic fields within said passage holes of said outer magnetic member, said cavity, and said passage holes of said inner magnetic member developing a magnetic flow path for said fuel throughout said fuel magnetizer for enhancing said fuel vaporization concerning said efficiency improvement.

5. The method of claim 1, wherein an alternative fuel magnetizer, being disposed and attached on the inner wall of an outlet end defined by a housing means in said device, performing said magnetizing process to magnetize said attributes of said fuel passing from an inner chamber defined by said housing means, comprising:
a) an outer cylindrical magnetic member having a plurality of keyways around the external cylindrical surface of said outer magnetic member to be inserted into by a plurality of respective splines of a tubular sleeve correspondingly and an inner cylindrical magnetic member having a plurality of keyways around the external cylindrical surface of said inner magnetic member to be inserted into by a plurality of respective splines of said tubular sleeve correspondingly, both said outer magnetic member and said inner magnetic member being made of Nd—Fe—B permanent magnet, and said outer magnetic member having a plurality of round passage holes to allow said fuel to exit out said magnetizer and a plurality of cylinder projections to extend into the corresponding round passage holes of said inner magnetic member to create magnetic fields within said passage holes and said inner magnetic member having a plurality of round passage holes to allow said fuel to enter into said magnetizer and a plurality of cylinder projections to extend into corresponding the round passage holes of said outer magnetic member to create magnetic fields within said passage holes; and
b) said tubular sleeve made of fuel resistance materials having an attached annulus over the center portion of the internal surface of said tubular sleeve, having two respective splines over one side of said internal surface of said tubular sleeve to insert into said keyways of said outer magnetic member correspondingly and having two respective splines over other side of said internal surface of said tubular sleeve to insert into said keyways of said inner magnetic member correspondingly, said annulus separating said outer magnetic member from said inner magnetic member to define a cavity with a magnetic field within said cavity because of Nd—Fe—B permanent magnet and extending from said internal surface of said tubular sleeve into said cavity, and said cavity providing excessive fuel flowing from said inner magnetic member to be accumulated and to be treated there by a magnetic field generated by said Nd—Fe—B permanent magnet prior to entrance into said outer magnetic member,
whereby said fuel magnetizer utilizing said splines and said keyways to hold said tubular sleeve, said outer magnetic members, and said inner magnetic members as a cohesive unit and said magnetic fields within said passage holes of said outer magnetic member, said cavity, and said passage holes of said inner magnetic member developing a magnetic flow path for said fuel throughout said fuel magnetizer for enhancing said fuel vaporization concerning said efficiency improvement.
